(19) United States
(12) Patent Application Publication
(10) Pub. No.: US 2026/0106716 A1
(43) Pub. Date: Apr. 16, 2026

(54) EARLY ACKNOWLEDGMENT-TRIGGERING DATA STALL MITIGATION SYSTEM AND METHODS

(71) Applicant: Apple Inc., Cupertino, CA (US)

(72) Inventors: Alosious Pradeep Prabhakar, Singapore (SG); Han Pu, Shanghai (CN); Vijay Venkataraman, San Jose, CA (US)

(21) Appl. No.: 18/912,467

(22) Filed: Oct. 10, 2024

(51) Int. Cl. H04L 5/00; H04W 28/06; H04W 76/30

(52) U.S. Cl. CPC H04L 5/0055; H04W 28/06; H04W 76/30

(57) ABSTRACT

User equipment-based mitigations may improve device operation by mitigating data stalls with fewer overall computing resources being used to do so. For example, the user equipment performing a user equipment-based mitigation may itself initiate the reset, improving a time to remedy the data stall while reducing or eliminating a likelihood of the data stall being perceivable from a performance impact perspective. Moreover, further improvements to flexibility of communication network deployment may also be realized from the systems and methods described herein by introducing operations through which user equipment may detect network characteristics and change its own operation based on the detected network characteristics.

### BACKGROUND

The present disclosure relates generally to wireless communication, and more specifically to acknowledgment messages from a network.

In a wireless communication system, a user equipment may communicate with an endpoint device via network devices of a network provider. To reduce overall transmission times, some network devices may transmit an early acknowledgment message to the user equipment before receiving an actual acknowledgment message from the endpoint device indicating that a message transmitted from the user equipment was successfully received at the endpoint device. This may lead to integration issues with legacy operations of the user equipment.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, an apparatus may include a memory operable to store a flow table. The flow table may include one or more entries updated based on acknowledgment messages received relative to an active communication session with an endpoint system. The system may include transceiver circuitry and processing circuitry. The transceiver circuitry may enable communication between the apparatus and the endpoint system via the active communication session. The processing circuitry may operate the transceiver circuitry to receive an early acknowledgment message. The processing circuitry may operate the transceiver circuitry to receive a negative acknowledgment message corresponding to the active communication session. The negative acknowledgment message may be received, via operation of the transceiver circuitry, after the early acknowledge message. The processing circuitry may mitigate a data stall based on receiving the negative acknowledgment message after the early acknowledgment message. In some cases, a system includes the apparatus, an endpoint system, and an intermediate router network that includes multiple routers. A respective router of the intermediate router network may send the early acknowledgement message via the active communication session. The apparatus may communicate with the endpoint system via the active communication session, based on uplink and downlink operations over a wireless communication network provided based on the intermediate router network.

In another embodiment, a non-transitory, computer-readable medium may store computer-readable instructions that, when executed by one or more processors of one or more computers, cause the one or more computers to perform operations. The operations may include accessing a flow table, where the flow table may include one or more entries updated based on acknowledgment messages received relative to an active communication session with an endpoint system. The operations may include receiving an early acknowledgment message. The operations may include receiving, after the early acknowledgment message, a negative acknowledgment message corresponding to the active communication session. The operations may include mitigating a data stall based on the negative acknowledgment message based on the one or more entries and receiving the negative acknowledgment message after the early acknowledgment message.

In yet another embodiment, a method may include transmitting a packet via a communication session, a copy of the packet being retained in memory. The memory may include receiving, from a router, an early acknowledgment message corresponding to the packet. The method may include deleting, from memory, the copy of the packet based on the early acknowledgment message. The method may include receiving, after the early acknowledgment message, a negative acknowledgment message associated with the communication session. The method may include mitigating a data stall based on the negative acknowledgment message.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a functional diagram of the electronic device of FIG. 1, including a transmitter and a receiver as the transceiver of FIG. 1, according to embodiments of the present disclosure;

FIG. 3 is a schematic diagram of an example user equipment and endpoint system communicating via a router that is not enabled to transmit an early acknowledgment message (early ACK), according to embodiments of the present disclosure;

FIG. 4 is a schematic diagram of the user equipment and the endpoint system of FIG. 3 communicating via an intermediate router network configurable to transmit an early ACK, according to embodiments of the present disclosure;

FIG. 5 is a schematic diagram of the user equipment and the endpoint system of FIG. 3 communicating via the intermediate router network of FIG. 4, where the user equipment experiences a data stall after receiving a negative acknowledgment message (NACK) after an early ACK, according to embodiments of the present disclosure;

FIG. 6 is a flowchart of a method for initiating a reset of a communication session in response to receiving a NACK from a router of the intermediate router network of FIG. 4 as a first data stall mitigation, according to embodiments of the present disclosure;

FIG. 7 is a flowchart of a method for determining to implement an override operation as a second data stall mitigation, according to embodiments of the present disclosure;

FIG. 8 is a flowchart of a method for performing the override operation to retain a copy of a packet transmitted via a communication session, according to embodiments of the present disclosure;

FIG. 9 is a flowchart of a method for determining characteristics of early ACKs of a communication network, which may be used with any of the methods of FIGS. 6-8, according to embodiments of the present disclosure; and

FIG. 10 is a flowchart of a method for identifying whether an acknowledgment message (ACK) is an early ACK based on example characteristics identified via methods of FIG. 9, which may be used with any of the methods of FIGS. 6-9, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on.

User equipment may communicate with an endpoint system to access services provided by the endpoint system, retrieve data stored on the endpoint device, or the like. An example endpoint system may include a server device. To communicate with the endpoint system, the user equipment may, through a communication network, uplink and/or downlink a signal with the endpoint system. The signal may be one of multiple signals sent or received from the endpoint system. The signal may include or be a part of data, a message, a packet, or the like. Such terms may be interchangeably used herein to generally describe communicable information uplinked or downlinked between devices of a wireless communication system. A respective signal transmitted may be a part of multiple signals of a packet flow. In some cases, uplink and downlink operations may use transmission control protocol (TCP) packets.

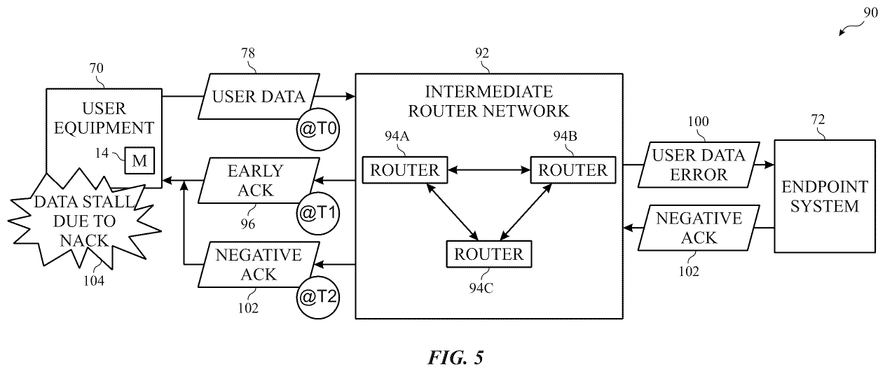

As user equipment is moved physically over time, the user equipment may connect to the endpoint device through different communication networks operated by different network providers and/or through different types of network devices. Different communication networks may have different network behaviors and operations employed. For example, some network devices may transmit an early acknowledgment message (early ACK) to the user equipment before receiving an actual acknowledgment message (ACK) from the endpoint system that data from the user equipment was successfully received. User equipment may use an ACK from the endpoint system to confirm receipt of data and, in response to the ACK, may delete a copy of the data in response (e.g., illustrated in FIG. 4). User equipment may receive the early ACK as earlier notice to start preparing to transmit a subsequent packet. As such, networks that use early ACK may communicate more efficiently relative to networks that do not use early ACK due to some latency savings from the use of the early ACK. However, the user equipment may not receive advance notification of whether a respective communication network uses an early ACK. This may lead to integration issues between operations of user equipment that may not distinguish between the early ACK and ACK.

For example, when early ACKs and ACKs are not distinguished between, the user equipment may delete a retained copy of uplinked data in response to an early ACK but before the uplinked data is properly received by the endpoint system. Should the data not be properly received by the endpoint system, the endpoint system may downlink a negative acknowledgment message (NACK). The user equipment that prematurely deleted the copy of the uplinked data may not be able to retransmit the uplinked data in response to the NACK. This may lead to the user equipment experiencing a data stall (e.g., illustrated in FIG. 5).

Resetting a communication session may reset a data stall. To reset, the user equipment may toggle a network connection off and on, such as by entering and exiting an “airplane” mode. From a user experience perspective, a data stall may be disruptive because the communication reset may occur while the user equipment is in the middle of active communication sessions with the endpoint device, such as actively exchanging data, actively making a call, actively using an application that operates based on data in the endpoint device, or the like. An active communication session may cause dynamic image content changes on a display, making a data stall relatively apparent and disruptive to a user viewing the image content on the display. Data stalls may interrupt user experiences through having to reset communications of the user equipment, through delayed response times of image content presented on the display, or the like.

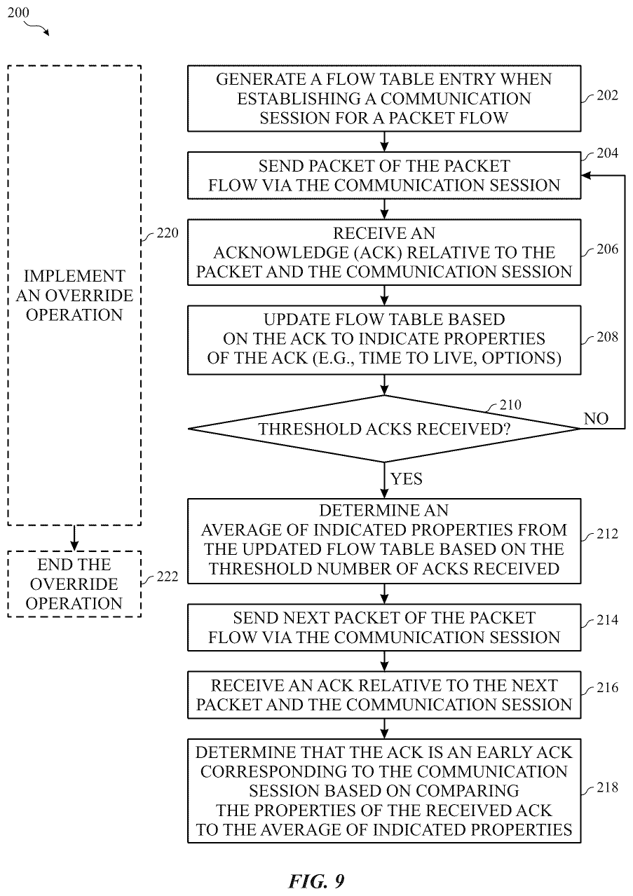

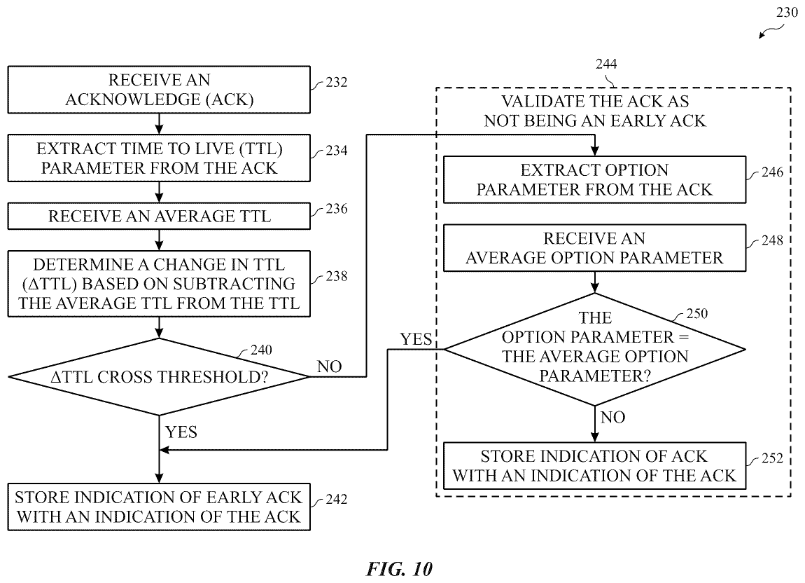

Systems and methods described herein may enable the user equipment to differentiate between early ACKs and ACKs. One method described herein involves identifying early ACKs based on an expected Time to Live (TTL) parameter and expected option parameters corresponding to the communication network (e.g., methods of FIG. 10). In some cases, the user equipment may analyze historical datasets of ACKs of the communication network to identify an expected TTL parameter and one or more expected option parameters for that communication network (e.g., methods of FIG. 9). Once differentiated between, the user equipment may mitigate an anticipated data stall or override deletion operations altogether to improve user experience and device operation.

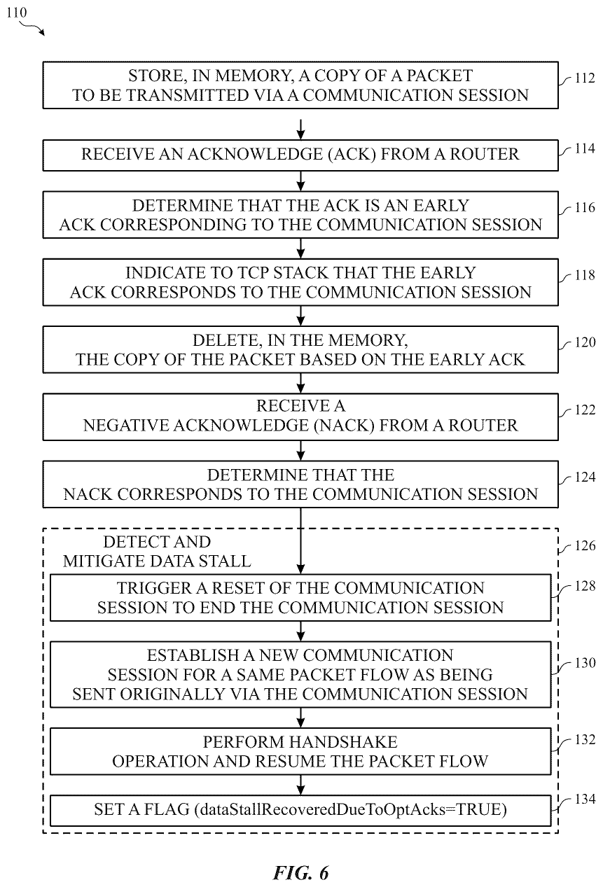

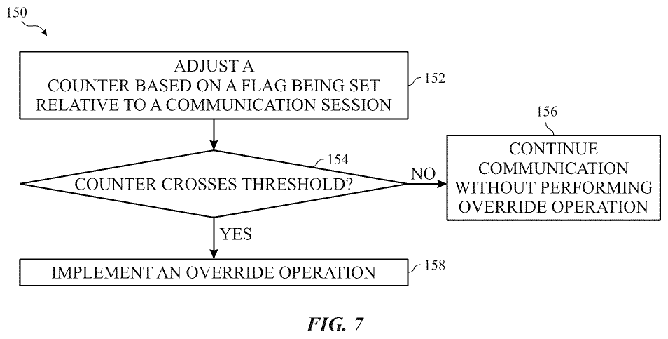

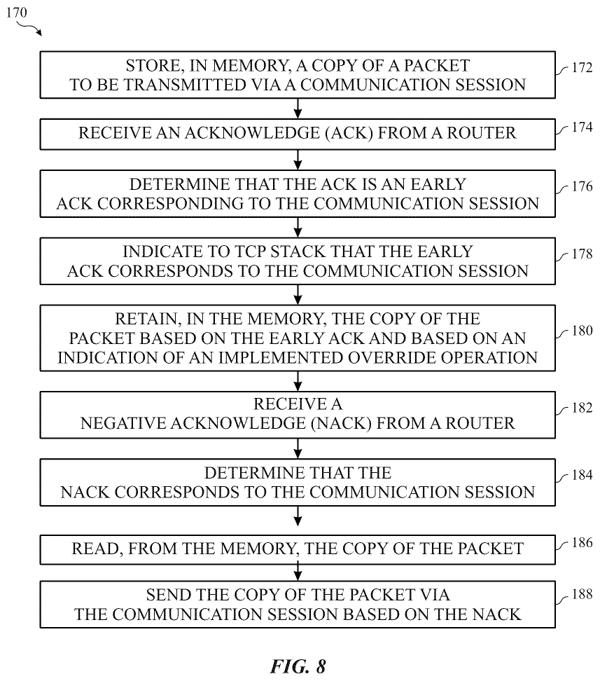

A first mitigation method may involve the user equipment initiating a communication session reset (e.g., operations of FIG. 6) to end a data stall. A second mitigation method may involve the user equipment overriding a default operation (e.g., override operations of FIG. 8) when communicating over a problematic network (e.g., identification operations of FIG. 7), where the default operation may include deleting a copy of previously sent data in response to receiving an early ACK. Either of these user equipment-based mitigations may improve device operation by mitigating data stalls with fewer overall computing resources being used to do so. For example, the user equipment performing the first mitigation method may itself initiate the reset, rather than waiting for a user to engage in their own frustrated debugging operations that may result in a full device power cycle, repeated input receipt that may cause undesirable computing responses, or other attempted solutions. Through user equipment mitigating its own data stall, a likelihood of the data stall being perceivable by a user may be reduced or eliminated.

Keeping the foregoing in mind, FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, storage 16, a display 18, input structures 22, an input/output (I/O) interface 24, a network interface 26, and a power source 32. The various functional blocks shown in FIG. 1 may include hardware elements (including circuitry), software elements (including machine-executable instructions) or a combination of both hardware and software elements (which may be referred to as logic). The processor 12, memory 14, the storage 16, the display 18, the input structures 22, the input/output (I/O) interface 24, the network interface 26, and/or the power source 32 may each be communicatively coupled directly or indirectly (e.g., through or via another component, a communication bus, a network) to one another to transmit and/or receive data between one another. It should be noted that FIG. 1 is merely one example of a particular implementation and is intended to illustrate the types of components that may be present in electronic device 10.

By way of example, the electronic device 10 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple Inc. of Cupertino, California), a wearable electronic device (e.g., in the form of an Apple Watch® by Apple Inc. of Cupertino, California), and other similar devices. It should be noted that the processor 12 and other related items in FIG. 1 may be generally referred to herein as “data processing circuitry.” Such data processing circuitry may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a storage 16 to perform various algorithms. Such programs or instructions executed by the processor 12 may be stored in any suitable article of manufacture that includes one or more tangible, computer-readable media. The tangible, computer-readable media may include the memory 14 and/or the storage 16, individually or collectively, to store the instructions or routines. The memory 14 and the storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies. It should be understood that, in some embodiments, the electronic device 10 may not have a display 18, such as in the case of the electronic device 10 being a server, router, communication hub, and so on.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 26 may include, for example, one or more interfaces for a personal area network (PAN), such as an ultra-wideband (UWB) or a BLUETOOTH® network, for a local area network (LAN) or wireless local area network (WLAN), such as a network employing one of the IEEE 802.11x family of protocols (e.g., WI-FI®), and/or for a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, and/or New Radio (NR) cellular network, a satellite network, and so on. In particular, the network interface 26 may include, for example, one or more interfaces for using a Release-15 cellular communication standard of the 5G specifications that include the millimeter wave (mmWave) frequency range (e.g., 24.25-300 gigahertz (GHz)) and/or any other cellular communication standard release (e.g., Release-16, Release-17, any future releases) that define and/or enable frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. The power source 32 of the electronic device 10 may include any suitable source of power, such as a rechargeable lithium polymer (Li-poly) battery and/or an alternating current (AC) power converter. In certain embodiments, the electronic device 10 may take the form of a computer, a portable electronic device, a wearable electronic device, or other type of electronic device.

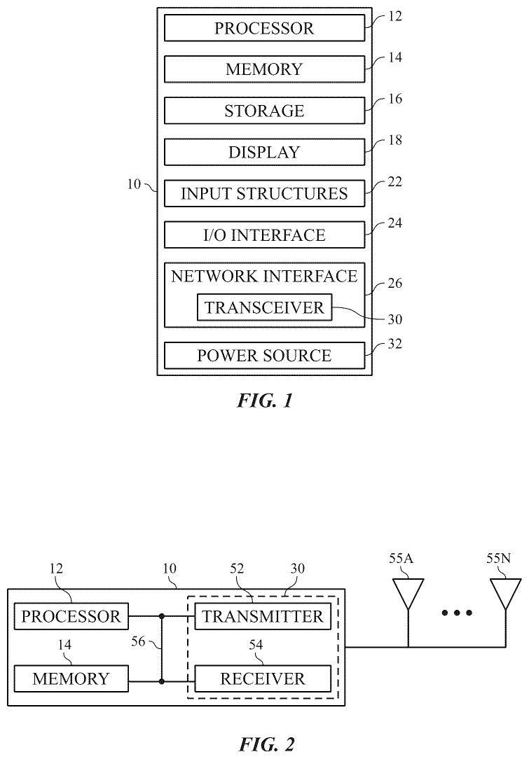

FIG. 2 is a functional diagram of the electronic device 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) may be communicatively coupled directly or indirectly (e.g., through or via another component, a communication bus, a network) to one another to transmit and/or receive data between one another.

The electronic device 10 may include the transmitter 52 and/or the receiver 54 that respectively enable transmission and reception of data between the electronic device 10 and an external device via, for example, a network (e.g., including base stations) or a direct connection. As illustrated, the transmitter 52 and the receiver 54 may be combined into the transceiver 30. The electronic device 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with a one or more beams and various configurations. In some embodiments, multiple antennas of the antennas 55A-55N of an antenna group or module may be communicatively coupled to a respective transceiver 30. One or more of the antennas 55A-55N may each emit radio frequency signals that may constructively and/or destructively combine to form a beam. The electronic device 10 may include multiple transmitters, multiple receivers, multiple transceivers, and/or multiple antennas as suitable for various communication standards. In some embodiments, the transmitter 52 and the receiver 54 may transmit and receive information via other wired or wireline systems or means.

As illustrated, the various components of the electronic device 10 may be coupled together by a bus system 56. The bus system 56 may include a data bus, for example, as well as a power bus, a control signal bus, and a status signal bus, in addition to the data bus. The components of the electronic device 10 may be coupled together or accept or provide inputs to each other using some other mechanism.

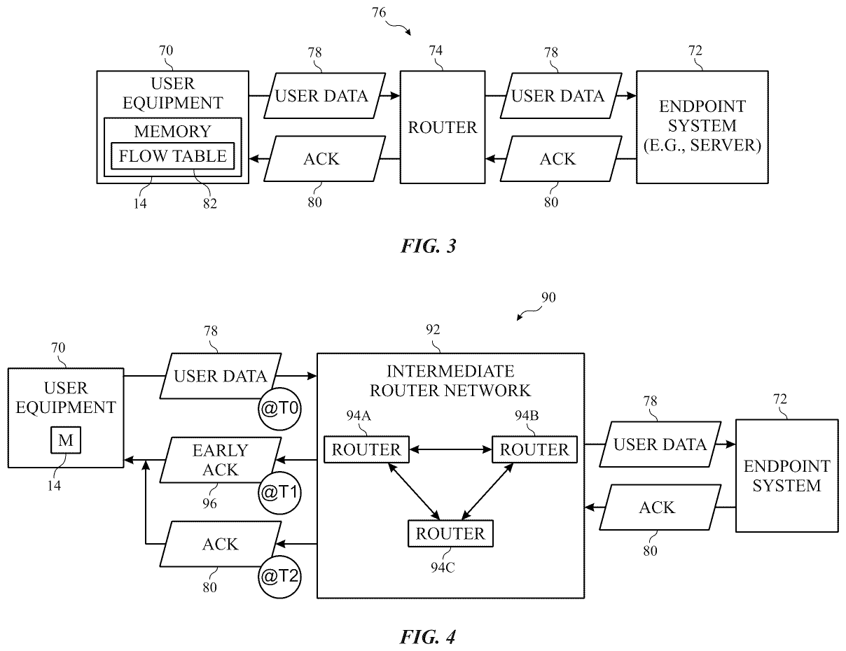

User equipment may execute instructions stored in memory to run applications. Some applications or other user equipment operations may operate based on data being sent to, received from, or exchanged with an endpoint system, such as a server. Data may be sent between the user equipment and the endpoint system over a communication network. An example system of such is illustrated in FIG. 3.

FIG. 3 is a schematic diagram of an example of user equipment 70 and an endpoint system 72, such as a server, a database, another electronic device, or the like. The electronic device 10 may correspond to components of the user equipment 70, the endpoint system 72, a router 74, or other suitable components of a communication network 76. As described herein relative to FIGS. 3-10, specific reference may not be made back to FIG. 1 but it should be understood that those descriptions of components apply to other electronic devices described herein, such as the user equipment 70, the endpoint system 72, the routers 74, intermediate router network circuitry of FIG. 4, and so on. For example, the user equipment 70 may be any suitable electronic device 10 that generates data to be sent via a communication network, like a communication network 76. The endpoint system 72 may include any suitable electronic device 10 that receives the data from user equipment 70 via the communication network. Some endpoint systems 72 may downlink data to user equipment 70 based on the data received, via an uplink operation, from the user equipment 70. The user equipment 70 and/or the endpoint system 72 may be coupled to the communication network 76 through the network interface 26, the I/O interface 24, or the like described above relative to FIG. 1.

The user equipment 70 and the endpoint system 72 may communicate via a communication network 76. The communication network 76 may be implemented by a network provider based on one or more network devices, such as the router 74. The router 74 may not be enabled to transmit an early acknowledgment message (early ACK). The communication network 76 may include other network devices, like network switches, base stations, backhauls, gateways, and the like.

The user equipment 70 may generate data. The user equipment 70 may transmit the data as part of a payload of a packet. The data may be any data transmittable to the endpoint system 72, such as user data, application data, device data, and the like. Although the user equipment 70 may transmit any suitable data to the endpoint system 72, for ease of disclosure, systems and methods are described herein relative to user data 78 being generated by the user equipment 70. User data 78 is an example of data that may be transmitted through systems and methods described herein.

The user equipment 70 may use an uplink operation to transmit the user data 78 via the communication network 76. The router 74 may receive the user data 78 and forward the user data 78 to the endpoint system 72. The endpoint system 72 may use a downlink operation to receive the user data 78 from the router 74. The endpoint system 72 may confirm receipt of the user data 78 by generating an acknowledgment message (ACK) 80. The endpoint system 72 may use an uplink operation to transmit the ACK 80 to the router 74. The router 74 may receive the ACK message 80 and forward the ACK 80 to the endpoint system 72. The user equipment 70 may use a downlink operation to receive the ACK 80 from the router 74.

The user equipment 70 may store an indication of a flow table 82 in the memory 14. It is noted that some systems may store an indication of the flow table 82 in the storage 16 or another suitable memory component. The flow table 82 may include different entries for each active packet flow. For example, the user equipment 70 operating to provide a web-enabled browser application may operate to store different entries in the flow table 82 for each website browsing session maintained via the web-enabled browser application. The flow table 82 may include data for each of the different entries corresponding to Time to Live (TTL) parameters, option parameters, and the like associated with each received ACK.

In FIG. 3, the router 74 may not transmit an early ACK. The router 74 may wait to receive the ACK 80 from the endpoint system 72. After receipt, the router 74 may forward the ACK 80 to the user equipment 70, which indicates to the user equipment 70 that user data 78 was received without error at the endpoint system 72. Comparing FIG. 3 and FIG. 4, FIG. 4 illustrates an example communication network that transmits an early ACK in anticipation of the user data being successfully received by the endpoint system 72.

To elaborate, FIG. 4 is a schematic diagram of the user equipment 70 and the endpoint system 72 communicating via communication network 90. The communication network 90 may operate based on an intermediate router network 92. The user equipment 70 may generate the user data 78 and use an uplink operation to transmit (e.g., at an initial time, t0) to the endpoint system 72 via the intermediate router network 92. The intermediate router network 92 may include multiple routers 94 (router 94A, router 94B, router 94C).

One or more of the routers 94 may be configurable to transmit an early acknowledgment message (early ACK) 96 (e.g., at first time, t1) in response to receiving uplinked data, such as user data 78 from the user equipment 70. One of the routers 94 may be operated to transmit the early ACK 96 to the user equipment 70 before receiving the ACK 80 from the endpoint system 72. The early ACK 96 may indicate to the user equipment 70 that the endpoint system 72 successfully received one or more signals from the user equipment 70. The signals from the user equipment 70 may be any suitable signaling, which may include data uplinked from the user equipment 70, The router 94 may generate the early ACK 96 before the respective router 94 itself has received the ACK 80 from the endpoint system 72. The endpoint system 72 may transmit the ACK 80 as confirmation of a successful uplink at a time (e.g., between a first time, t1, and a second time, t2) after the intermediate router network 92 sent the early ACK 96 (e.g., at a first time, t1). When the processor 12 of the user equipment 70 is unable to differentiate between the ACKs 80 and early ACKs 96, the processor 12 may flush a payload of the user data 78 retained in memory 14 in response to the early ACK 96, treating it as an ACK 80. For example, the user equipment 70 may flush a payload of a TCP packet when the communication network 90 is based on TCP. The user equipment 70 may flush the payload at an at least partially overlapping time with the intermediate router network 92 transmitting the user data 78 to the endpoint system 72 (e.g., between a first time, t1, and a second time, t2). The endpoint system 72 may respond to a successful uplink by transmitting an ACK 80 (e.g., at a second time, t2) to the intermediate router network 92 as an indication of the successful uplink, which transmits the ACK 80 to the user equipment 70. The user equipment 70 may regard the second ACK 80 received for the uplink operation as a duplicate ACK 80 and may discard it (e.g., after second time, t2).

User equipment 70 may use an ACK 80 from the endpoint system 72 to confirm completed receipt of data and, in response to the ACK 80, may delete or flush a copy of the user data 78 in response (e.g., illustrated in FIG. 4). The user equipment 70 may handle early ACKs and ACKs in a same or similar way, which may cause premature deletion of a copy of the user data 78. Although FIG. 4 illustrates a case where the user data 78 was properly received without error by the endpoint system 72, FIG. 5 illustrates a case where the endpoint system 72 does not receive the user data 78, as may occur when uplinked data is dropped or miscommunicated mid-uplink operation.

FIG. 5 is a schematic diagram of the user equipment 70 and the endpoint system 72 communicating via the intermediate router network 92, where the user equipment 70 may experience a data stall (e.g., operational indicator 104) after receiving a negative acknowledgment message (NACK) 102 subsequent to the early ACK 96.

When early ACKs and ACKs are not distinguished between, the user equipment 70 may delete a retained copy of user data 78 in response to what should be considered an early ACK 96, treating it like an ACK 80. A processor 12 of the user equipment 70 may operate a cache memory or memory 14 to delete the retained copy of the user data 78. This deletion may occur before the user data 78 is properly received by the endpoint system 72.

Should the endpoint system 72 ultimately not receive the user data 78 (e.g., illustrated via user data error 100 indication), the endpoint system 72 may downlink a negative acknowledgment message (NACK) 102 to indicate the incomplete uplink operation. The intermediate router network 92 may receive and transmit the NACK 102 to the user equipment 70. Since the user equipment 70 may delete a copy of the user data 78 when treating early ACKs 96 like ACKs 80, the user equipment 70 is unable to retransmit the user data 78 in response to the NACK 102. This may lead to the user equipment 70 experiencing a data stall (e.g., illustrated in FIG. 5 as operational indicator 104). Data stalls may interrupt user experiences through having to reset communications of the user equipment, through delayed response times of image content presented on the display, or the like, as described herein.

If user equipment 70 were to be able to differentiate between ACKs 80 and early ACKs 96, the user equipment 70 may be able to perform operations to mitigate a data stall, or predict when a communication network uses early ACK infrastructure and methods (e.g., like the communication network 90). Doing so may improve device operation and user experiences with the user equipment 70, among other technical improvements. Such operations of the processor 12 may be described relative to FIGS. 6-10.

To elaborate, a first mitigation may involve the user equipment initiating a communication session reset to end a data stall (e.g., operations of FIG. 6). FIG. 6 is a flowchart of a method 110 for the user equipment 70 to mitigate its own data stall through initiating a reset of a communication session in response to receiving a NACK 102, according to embodiments of the present disclosure. Any suitable device (e.g., a controller) that may control components of the user equipment 70, such as the processor 12, may perform the method 110. In some embodiments, the method 110 may be implemented by executing instructions stored in a tangible, non-transitory, computer-readable medium, such as the memory 14 or storage 16, using the processor 12. For example, the method 110 may be performed at least in part by one or more software components, such as an operating system of the user equipment 70, one or more software applications of the electronic device 10, and the like. While the method 110 is described using steps in a specific sequence, it should be understood that the present disclosure contemplates that the described steps may be performed in different sequences than the sequence illustrated, and certain described steps may be skipped or not performed altogether.

In process block 112, the processor 12 stores, in memory 14, a copy of a packet to be transmitted via a communication session. The packet to be transmitted may be user data 78 to be sent to the endpoint system 72. The processor 12 may generate the user data 78 while executing instructions to provide an application or other web-based software that a user of the user equipment 70 may interact with via input structures 22 or other suitable methods of input. For ease of description, the example of the communication session being a transmission control protocol (TCP) session is used and referred to herein. It should be noted that this disclosure may be similarly applied to other suitable types of communication sessions, and that TCP sessions are used as an example herein. Other types of communication sessions that may benefit from using systems and methods described herein may include user datagram protocol (UDP) communications, file transfer protocol (FTP) communications, border gateway protocol methods, real-time transport protocol (RTP), simple network management protocol (SNMP), or the like.

In process block 114, the processor 12 receives an ACK 80 (e.g., early ACK 96 undistinguished from ACK 80 by the processor 12 here at initial receipt) from a respective router 94 of the intermediate router network 92. The respective router 94 may be a first router of the routers 94 to receive the packet from the user equipment 70. Different routers 94 may transmit ACKs 80 at different times based on which receives the packet. The respective router 94 may transmit the ACK 80 before receiving the ACK 80 from the endpoint system 72. In doing so, the respective router 94 may operate similar to the endpoint system 72 and generate its own ACK 80 as a confirmation of its own receipt of the uplinked packet. Since user equipment 70 receives the ACK 80 before the endpoint system 72 actually receives the uplinked packet, the ACK 80 is an early ACK 96. The early ACK 96 may be an optimistic ACK (e.g., generated by the intermediate router network 92 as part of consented or desired operations to promote system efficiency) or spurious ACK (e.g., generated by a third-party device as part of unconsented or undesired operations).

In process block 116, the processor 12 determines that the ACK 80 is the early ACK 96 corresponding to the communication session. The processor 12 may use any suitable method to differentiate between the ACK 80 and the early ACK 96. For example, methods of FIG. 10 may be used to differentiate between ACKs 80 and early ACKs 96.

In process block 118, the processor 12 indicates to a TCP stack that the early ACK 96 corresponds to the communication session. The processor 12 may not change operation in response to determining that the ACK was an early ACK 96 as opposed to an ACK 80 triggered by the endpoint system 72. Indeed, the processor 12 may proceed to delete the copy of the uplinked packet in response to the ACK 80.

In process block 120, the processor 12 deletes the copy of the packet. The processor 12 may operate the memory 14 or a cache memory to delete the copy of the packet in response to the early ACK 96 determination of process block 116.

In process block 122, the processor 12 receives a NACK 102 from a respective router 94 of the intermediate router network 92. The respective router 94 to transmit the NACK 102 may be a first of the routers 94 to receive the NACK 102 from the endpoint system 72.

In process block 124, the processor 12 determines that the NACK 102 corresponds to the communication session. The processor 12 may determine which of one or more ongoing communication sessions that the NACK 102 corresponds to through data included with the NACK 102. For example, the processor 12 may extract data from the NACK 102 that identifies the communication session.

In process block 126, the processor 12 performs operations of process blocks 128-134 to mitigate a data stall. By mitigating the data stall, the processor 12 may reduce a likelihood or prevent a data stall from being perceivable via a graphical user interface presented on the display 18.

In process block 128, the processor 12 triggers a reset of the communication session. The reset of the communication session may end the communication session. The processor 12 may trigger a TCP reset in response to determining, at process block 124, that the NACK 102 corresponds to the communication session.

In process block 130, the processor 12 establishes a new communication session to continue to transmit the packet flow reset in process block 128. In response to triggering the reset of the communication session, the processor 12 may establish a new communication session for the same packet flow as being sent originally via the communication session. For example, the processor 12 may establish a new TCP socket or connection as the new communication session. The processor 12 may store an indication in the flow table 82 to aid identification of the same packet flow between resetting the communication session and establishing the new communication session.

In process block 132, the processor 12 performs a handshake operation and resumes the packet flow. As part of establishing the new communication session, the processor 12 may perform a handshake operation to restart the communication session. Performing the handshake operation may involve reading identifying data from the flow table 82. For example, a TCP three-way handshake may be performed before the packet flow resumes.

In process block 134, the processor 12 sets a flag. The flag may be used to track a number of times that an incomplete uplink operation occurred. As an example, the flag may correspond to “dataStallRecoveredDueToOptsAcks=TRUE” and any suitable flag may be used. The processor 12 may detect and respond to a threshold number of incomplete uplink operations using operations described herein relative to FIGS. 7-8.

To elaborate, a second mitigation may involve the user equipment 70 overriding a default operation (e.g., override operations of FIG. 8) when communicating over a network identified as repeatedly involving incomplete data uplink operations (e.g., identification operations of FIG. 7). The default operation overridden may involve the user equipment 70 deleting a copy of previously uplinked data in response to receiving an early ACK.

FIG. 7 is a flowchart of a method 150 for the user equipment 70 to selectively implement an override operation as a second data stall mitigation, according to embodiments of the present disclosure. Any suitable device (e.g., a controller) that may control components of the user equipment 70, such as the processor 12, may perform the method 150. In some embodiments, the method 150 may be implemented by executing instructions stored in a tangible, non-transitory, computer-readable medium, such as the memory 14 or storage 16, using the processor 12. For example, the method 150 may be performed at least in part by one or more software components, such as an operating system of the user equipment 70, one or more software applications of the electronic device 10, and the like. While the method 150 is described using steps in a specific sequence, it should be understood that the present disclosure contemplates that the described steps may be performed in different sequences than the sequence illustrated, and certain described steps may be skipped or not performed altogether.

In process block 152, the processor 12 adjusts a counter based on a flag being set relative to a communication session. As an example, the flag may correspond to “dataStallRecoveredDueToOptsAcks=TRUE” and any suitable flag may be used. The processor 12 may have set the flag to indicate that an incomplete uplink operation occurred (e.g., in process block 134 of FIG. 6). By adjusting the counter, the processor 12 may track a number of occurrences of an incomplete uplink operation.

In process block 154, the processor 12 determines whether a count indicated by the counter crosses a threshold. When the processor 12 determines that the count indicated by the counter does not cross the threshold, the processor 12 continues, in process block 156, communicating without performing an override operation. The processor 12 may, in some cases, continue to perform operations of the method 110 described relative to FIG. 6, initiating the flag whenever a data stall occurs and generally waiting until a threshold number of data stalls have occurred.

However, when the processor 12 determines that the count indicated by the counter does cross the threshold, the processor 12 continues, in process block 158, to implement the override operation. The processor 12 may store an indication of the decision to implement the override operation in memory 14 or storage 16. The override operation may cause the copy of the packet to be retained in memory after receiving the early ACK. The count crossing the threshold may indicate to the processor 12 that the communication network 90 may be less reliable and thus less suited to incorporate early ACKs 96. To avoid or reduce a likelihood of data stalls, the processor 12 may proactively change its operation to implement the override operation. The override operation may temporarily stop the deletion or flushing operations of process block 120 of the method 110 described relative to FIG. 6. The override operation may enable the processor 12 to retransmit the copy of the uplinked packet in the event that the endpoint system 72 ultimately not receive the uplinked packet (e.g., illustrated via user data error 100 indication). Details regarding an example override operation are described herein at least relative to FIG. 8.

FIG. 8 is a flowchart of a method 170 for the user equipment 70 to implement the override operation of FIG. 7, causing retention of a copy of a packet transmitted via a communication session (e.g., a previously uplinked packet), according to embodiments of the present disclosure. Any suitable device (e.g., a controller) that may control components of the user equipment 70, such as the processor 12, may perform the method 170. In some embodiments, the method 170 may be implemented by executing instructions stored in a tangible, non-transitory, computer-readable medium, such as the memory 14 or storage 16, using the processor 12. For example, the method 170 may be performed at least in part by one or more software components, such as an operating system of the user equipment 70, one or more software applications of the electronic device 10, and the like. While the method 170 is described using steps in a specific sequence, it should be understood that the present disclosure contemplates that the described steps may be performed in different sequences than the sequence illustrated, and certain described steps may be skipped or not performed altogether.

In process block 172, the processor 12 stores a copy of the packet to be transmitted via a communication session. In process block 174, the processor 12 receives an ACK 80 from a respective router 94. In process block 176, the processor 12 determines that the ACK 80 is an early ACK 96 corresponding to the communication session from process block 172. In process block 178, the processor 12 indicates to the TCP stack that the early ACK 96 corresponds to the communication session from process block 172. Operations of process blocks 172-178 may be similar or identical to operations described of process blocks 112-118 of method 110 described relative to FIG. 6, and thus are relied on herein.

In process block 180, the processor 12 retains the copy of the packet based on the early ACK 96 and based on an indication of an implemented override operation. The processor 12 may read, from memory 14 or storage 16, an indication of the decision to implement the override operation. In the override operation, the processor 12 does not delete the copy of the packet based on the early ACK 96. The processor 12, in the override operation, retains the copy of the packet despite the early ACK 96. The override operation enables the processor 12 to supply the copy of the packet if a NACK 102 is received or delete the copy of the packet if a ACK 80 is received from the endpoint system 72. For example, in process block 182, the processor 12 receives the NACK 102 from a respective router 94. In process block 184, the processor 12 determines that the NACK 102 corresponds to the communication session of process block 172. In response to the determination, in process block 186, the processor 12 reads the copy of the packet from the cache or memory 14. In process block 188, the processor 12 transmits the copy of the packet via the communication session back on the NACK 102.

Any suitable identification method may be used with the methods of FIGS. 6-8 to differentiate between an early ACK 96 and an ACK 80. One example method may involve the user equipment 70 analyzing historical datasets of ACKs 80 to identify an expected TTL parameter and one or more expected option parameters for that communication network (e.g., methods of FIG. 9), then differentiating between early ACKs 96 and ACKs 80 based on the expected Time to Live (TTL) parameter and expected option parameters determined for that communication network (e.g., methods of FIG. 10). Once differentiated between, the user equipment may mitigate an anticipated data stall or override deletion operations altogether to improve user experience and device operation based on the methods of FIGS. 6-8.

To elaborate, FIG. 9 is a flowchart of a method 200 for the user equipment to determine characteristics of early ACKs 96 of a communication network 90, which may be used with any of the methods of FIGS. 6-8, according to embodiments of the present disclosure. Any suitable device (e.g., a controller) that may control components of the user equipment 70, such as the processor 12, may perform the method 200. In some embodiments, the method 200 may be implemented by executing instructions stored in a tangible, non-transitory, computer-readable medium, such as the memory 14 or storage 16, using the processor 12. For example, the method 200 may be performed at least in part by one or more software components, such as an operating system of the user equipment 70, one or more software applications of the electronic device 10, and the like. While the method 200 is described using steps in a specific sequence, it should be understood that the present disclosure contemplates that the described steps may be performed in different sequences than the sequence illustrated, and certain described steps may be skipped or not performed altogether. The processor 12 may perform operations of process blocks 202-212 while initializing a new connection with a communication network and operations of process blocks 214-218 after initializing the connection with the communication network.

In process block 202, the processor 12 generates an entry in the flow table 82 when establishing a communication session for a packet flow. The communication session may be a TCP session. In process block 204, the processor 12 transmits a packet of the packet flow via the communication session. The packet may be a TCP packet. The packet to be transmitted may be user data 78 to be sent to the endpoint system 72. The processor 12 may generate the packet while executing instructions to provide an application or other web-based software that a user of the user equipment 70 may interact with via input structures 22 or other suitable methods of input. The processor 12 may transmit the packet over the communication network 90.

In process block 206, the processor 12 may receive an ACK 80. A respective router 94 may generate the ACK 80 in response to receiving the packet of the communication session. The processor 12 may determine the relationship between the ACK 80, the packet, and the communication session based on data transmitted with the ACK 80.

In process block 208, the processor 12 may update the flow table 82 based on the ACK 80 to indicate one or more properties of the ACK 80. The processor 12 may extract properties from the ACK 80, such as from the header or metadata of the ACK 80. The properties extracted may include a Time to Live (TTL) parameter, options parameters, or the like. The processor 12 may adjust a count indication of a number of ACKs 80 received across each communication session between the user equipment 70 and the endpoint system 72 via the communication network 76, 90. In some systems, the count indication may be extracted from a number of rows and/or columns indicated in the flow table 82.

In process block 210, the processor 12 determines whether a threshold number of ACKs 80 were received. The processor 12 may compare the count indication of a number of ACKs 80 received to a threshold number of ACKs 80. When the count crosses the threshold number of ACKs 80, the processor 12 may proceed to process block 212 to process the set of ACKs 80 to determine a set of expected communication characteristics initialized to the characteristics of the set of ACKs 80.

In process block 212, the processor 12 determines an average of extracted properties from the updated flow table 82 based on the threshold number ACKs 80 being received and stored in memory 14. The processor 12 may determine in process block 212 one or more differentiating characteristics between ACKs 80 and/or early ACKs 96 for that endpoint system 72 and/or that communication network 90. The processor 12 may use the set of ACKs 80 received, at process block 206, iteratively over time to establish a baseline expected operation for that communication network. The processor 12 may develop the expected communication characteristics from the set of ACKs 80 received to initialize to the communication network. The processor 12 may store indications of expected characteristics of future ACKs 80 in memory 14 or storage 16. These indications may be used in subsequent operations to determine whether an ACK 80 received is an early ACK 96 sent by the communication network 90 (e.g., optimistic ACK) and/or by a third-party device (e.g., spurious ACK). After initializing to the communication network, the processor 12 may proceed operationally similarly to as described relative to operations of FIG. 6 with operations of process blocks 214-218.

In process block 214, the processor 12 may transmit a next packet of the packet flow via the communication session. The processor 12 may use an uplink operation to transmit the next packet. In process block 216, the processor 12 may receive an ACK 80 in response to transmitting the next packet of the packet flow via the communication session. Operations of process block 216 may be similar or identical to operations described of process blocks 114 of method 110 described relative to FIG. 6, and thus are relied on herein.

In process block 218, the processor 12 may determine that the ACK 80 is an early ACK 96. The processor 12 may extract data from the ACK 80, such as from a header of the ACK 80, that represent properties of the ACK 80. The processor 12 may compare the extracted data to the average of extracted properties determined at process block 212. In doing so, the processor 12 compares whether properties of the received ACK 80 are similar enough to the average properties of the previously received ACKs 80 of the communication network to flag the received ACK 80 as an early ACK 96. When the properties of the received ACK 80 are similar enough to the average properties, the processor 12 identifies the received ACK 80 as an early ACK at process block 218.

In some systems, the override operation of FIG. 8 may be used while performing some operations of the method 200 (e.g., process blocks 202-212) while initializing the connection with the communication network. A graphical representation of this operational overlap is illustrated in FIG. 8. In process block 220, the processor 12 implements an override operation (e.g., generally method 170 of FIG. 8) until a threshold number of ACKs 80 are received such that the average of extracted properties are determinable at process block 212. While performing the override operation, the processor 12 overrides a default operation to delete a copy of a packet in response to receiving the early ACK 96, causing retention of the copy of the packet in the memory 14 until the ACK 80 is received or until the NACK 102 is received. When the threshold number is received, the processor 12, in process block 222, ends the override operation. By doing so, the processor 12 returns to default operation (e.g., method 110) of deleting the copy of the packet until determining that the communication network 90 is problematic (e.g., method 150).

FIG. 10 is a flowchart of a method 230 for identifying whether an ACK 80 is an early ACK 96 based on example characteristics identified via method 200, which may be used with any of the methods of FIGS. 6-9, according to embodiments of the present disclosure. Any suitable device (e.g., a controller) that may control components of the user equipment 70, such as the processor 12, may perform the method 230. In some embodiments, the method 230 may be implemented by executing instructions stored in a tangible, non-transitory, computer-readable medium, such as the memory 14 or storage 16, using the processor 12. For example, the method 230 may be performed at least in part by one or more software components, such as an operating system of the user equipment 70, one or more software applications of the electronic device 10, and the like. While the method 230 is described using steps in a specific sequence, it should be understood that the present disclosure contemplates that the described steps may be performed in different sequences than the sequence illustrated, and certain described steps may be skipped or not performed altogether.

In process block 232, the processor 12 receives an ACK 80. The ACK 80 may include a header that includes data, such as TTL parameters and option parameters. Other data the ACK 80 may include is a version identification data, a header length indication, a service type indication, a total length indication, an identification indication, one or more flag data, a fragment offset indication, protocol identification data, header checksum data, source internet protocol (IP) address, destination IP address, padding data, or the like.

In process block 234, the processor 12 extracts a subset of data from the ACK 80. For example, the processor 12 extracts a TTL parameter from the ACK 80.

In process block 236, the processor 12 receives an average TTL parameter from memory 14 or storage 16. The processor 12 may read or query such components to access the average option parameter. The processor 12 may have previously determined and stored the average of extracted properties in memory 14 or storage 16 at process block 212 of method 200 described relative to FIG. 9, where the average of extracted properties may include the average TTL parameter.

In process block 238, the processor 12 subtracts the average TTL parameter (e.g., from process block 236) from the TTL parameter (e.g., from process block 234) to identify a change in TTL (ΔTTL). Using ΔTTL, the processor 12 may compare an absolute value of ΔTTL to a threshold value of TTL to determine whether the change in TTL from the average TTL parameter is a large enough deviation to flag the ACK 80 as an early ACK 96. The TTL parameter may be relatively greater when the ACK 80 is an early ACK 96 since fewer inter-device transmissions (“hops”) may be used to transmit the ACK 80 to the destination device when compared to the ACK 80 is originated at the endpoint system 72.

In process block 240, the processor 12 determines whether the ΔTTL crosses a threshold. The memory 14 or storage 16 may store an indication of a change in TTL threshold corresponding to when ΔTTL indicates an early ACK 96.

When ΔTTL crosses the threshold, in process block 242, the processor 12 stores an indication of early ACK 96 with the indication of the ACK 80 in the flow table 82, otherwise in memory 14, or in storage 16. For example, the processor 12 may update the flow table 82 with the indication that the ACK 80 is an early ACK 96. The processor 12 may, at process block 116, 176, 218, or the like refer to the indication that the ACK 80 is an early ACK 96 generated and stored in process block 242.

In some systems, the processor 12 validates a determination that the ACK 80 is or is not an early ACK 96 by comparing the extracted subset of data from process block 234 to additional average parameters stored in memory 14 or storage 16. For example, in process block 244, the processor 12 validates the ACK 80 as not being an early ACK 96 based on operations of process blocks 246-250.

In process block 246, the processor 12 extracts an option parameter from the ACK 80. The option parameter may be extracted with the subset of data at process block 234.

In process block 248, the processor 12 receives an average option parameter from memory 14 or storage 16. The processor 12 may read or query such components to access the average option parameter. The processor 12 may have previously determined and stored the average of extracted properties in memory 14 or storage 16 at process block 212 of method 200 described relative to FIG. 9, where the average of extracted properties may include the average option parameter.

In process block 250, the processor 12 may determine whether the extracted option parameter matches the average option parameter. When the processor 12 determines that the option parameters match, the processor 12 may determine that the ACK 80 from process block 232 is indeed an early ACK 96 and may proceed to, in process block 242, store an indication of early ACK 96 with the indication of the ACK 80 in the flow table 82, otherwise in memory 14, or in storage 16.

However, returning to process block 250, when the processor 12 determines that the option parameters do not match, the processor 12 determines that the ACK 80 from process block 232 is not early ACK 96. In process block 252, the processor 12 stores an indication of the ACK 80 without an indication of early ACK 96 in the flow table 82, otherwise in memory 14, or in storage 16.

As described herein, communication networks 76 and 90 may operate based on various described components, such as routers 74 and/or routers 94. To elaborate, communication networks 76 and 90 may operate based on components including base stations. Base stations may include Next Generation NodeB (gNodeB or gNB) base stations and may provide 5G/NR coverage via communication network 76 and/or communication network 90 to the user equipment 70. The base stations may include any suitable electronic device, such as a communication hub or node, that facilitates, supports, and/or implements the communication network 76 and/or communication network 90. In some embodiments, the base stations may include Evolved NodeB (eNodeB) base stations and may provide 4G/LTE coverage via communication network 76 and/or communication network 90 to the user equipment 70. Each of the base stations may include at least some of the components of the user equipment 70 shown in FIGS. 1 and 2, including one or more processors 12, the memory 14, the storage 16, the transceiver 30, the transmitter 52, the receiver 54, and the associated circuitry shown in at least FIGS. 1 and 2. It should be understood that while the present disclosure may use 5G/NR as an example specification or standard, the embodiments disclosed herein may apply to other suitable specifications or standards (e.g., such as the 4G/LTE specification, a sub-4G specification, a beyond 5G specification, such as a 6G specification, and so on). Moreover, the communication network 76 and/or communication network 90 may include any suitable number of base stations (e.g., one or more base stations, four or more base stations, ten or more base stations, and so on).

Moreover, as described herein, TTL parameters may refer to the amount of time or “hops” that a packet is set to exist within a network before being discarded by a router 74 and/or router 94. TTL may also be referred to in additional contexts, such as content delivery network (CDN) caching and domain name system (DNS) caching. When a packet of information is created and distributed across a wireless network (e.g., communication network 76 and/or communication network 90), there is some likelihood that the packet continues on for a relatively long duration of time, sometimes much longer than what is generally desired. To mitigate this, packets may be designed with an expiration time called a time-to-live or hop limit. Packet TTL parameters may be useful in determining how long a packet has been in circulation for within the wireless network. Packet TTL parameters may also enable a transmitting system to receive information about a transmission path of a respective packet through the wireless network. Each packet may have a location within its dataset or header storing a numerical indication of how much longer that networked devices should continue to transmit that respective packet throughout the wireless network. The numerical indication may be a TTL count. Every time a router 74, 94 receives a packet, the router 74, 94 may adjust the numerical indication to account for the transmission of the packet to that router 74, 94. The router 74, 94 may transmit the packet to another networked device. Should the numerical indication cross a threshold, the router 74, 94 may discard the packet and transmit an internet control message protocol (ICMP) message back to the originating host device. The router 74, 94 may use the ICMP message to inform the originating host device that the packet expired before reaching the destination device. Some systems use a TTL count that decrements as it is transmitted, such that when the TTL count hits zero, the packet should be discarded by the router 74, 94.

Ping and traceroute operations may use TTL parameters. When using traceroute, a processor 12 may transmit a stream of packets with increasingly higher sequential TTLs over time (e.g., over the stream of packets) are sent across the wireless network towards a destination device. Because each step along the connection is a destination for one of the packets, each location returns an ICMP message to the originating host device after discarding the packet. The time taken for the ICMP message to return may be used to determine how long it takes to arrive to each successive hop along the wireless network.

It is noted that, as used herein, early ACK may refer to an acknowledgment message sent by a router of the communication network before an endpoint system has confirmed successful receipt of user data from user equipment. In some systems, an early ACK may correspond to as an optimistic acknowledgement, in that the router may generate the early ACK in anticipation of successful receipt by the endpoint system. In some cases, an early ACK may correspond to an undesirable device or unpermitted device, and thus the early ACK may correspond to a spurious acknowledgement (ACK). From a cybersecurity perspective, the spurious ACK may be an attempt to hack the user equipment through a malicious router or other malicious network component. A spurious ACK may cause a denial of service or other undesired user equipment operation, and thus be generally desired to avoid. Systems and methods described herein may further be used to differentiate early ACKs between optimistic ACKs and spurious ACKs based on determining average of extracted properties of optimistic ACKs for a respective communication network, and later using the average of extracted properties to detect when an early ACK does not match such expected properties to better flag and ignore spurious ACKs.

Technical effects include improved user equipment technical operations from a reduced likelihood of data stalls. User equipment-based mitigations may improve device operation by mitigating data stalls with fewer overall computing resources being used to do so. For example, the user equipment performing a UE-based mitigation may itself initiate the reset, improving a time to remedy the data stall while reducing or eliminating a likelihood of the data stall being perceivable from a performance impact perspective. Moreover, further improvements to flexibility of communication network deployment may also be realized from the systems and methods described herein by introducing operations through which a user equipment can detect network characteristics and change its own operation based on the detected network characteristics, independent of instruction from the communication network or endpoint system.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. An apparatus, comprising:
memory configurable to store a flow table comprising one or more entries updated based on acknowledgment messages received relative to an active communication session with an endpoint system;
transceiver circuitry configured to communicate with the endpoint system via the active communication session; and
processing circuitry configured to:
operate the transceiver circuitry to receive an early acknowledgment message corresponding to the active communication session;
operate the transceiver circuitry to receive a negative acknowledgment message corresponding to the active communication session; and
mitigate a data stall based on the negative acknowledgment message.

2. The apparatus of claim 1, wherein the processing circuitry is configured to:
operate the transceiver circuitry to transmit, via the active communication session, a packet to the endpoint system;
retain, in the memory, a copy of the packet; and
delete the copy of the packet from the memory based on receiving the early acknowledgment message.

3. The apparatus of claim 1, wherein the processing circuitry is configured to mitigate the data stall at least in part by:
ending the active communication session, the active communication session in progress of transmitting respective packets of a packet flow;
establishing a new communication session; and
operating the transceiver circuitry to transmit, via the new communication session, the packet flow.

4. The apparatus of claim 3, wherein the processing circuitry is configured to:
adjust, based on detection of the data stall, a counter that tracks a number of occurrences of data stalls overtime; and
cause, based on the number of the counter crossing a threshold, retention of a copy of a packet of the packet flow after determining that the early acknowledgment message was previously received.

5. The apparatus of claim 1, wherein the processing circuitry is configured to:
determine, based on the one or more entries, one or more extracted properties indicative of a plurality of acknowledgment messages previously transmitted via the active communication session;
operate the transceiver circuitry to receive, via the active communication session, an acknowledgment message;
extract one or more properties from the acknowledgment message; and
store, based on identifying the one or more properties as matching the one or more extracted properties, an indication in the flow table that the acknowledgment message is the early acknowledgment message.

6. The apparatus of claim 5, wherein the one or more properties comprise a Time-to-Live (TTL) parameter and one or more option parameters.

7. The apparatus of claim 1, wherein the processing circuitry is configured to:
initiate the active communication session;
update the flow table to indicate the active communication session; and
cause, based the flow table indicating the active communication session, retention of a copy of a packet of the active communication session.

8. The apparatus of claim 1, wherein the processing circuitry is configured to:
operate the transceiver circuitry to transmit, via the active communication session, a packet; and
operate the transceiver circuitry to receive, via the active communication session, the early acknowledgment message from a first router of an intermediate router network based on operating the transceiver circuitry to transmit the packet.

9. The apparatus of claim 8, wherein the processing circuitry is configured to operate the transceiver circuitry to receive, via the active communication session, the negative acknowledgment message from a second router of the intermediate router network.

10. A non-transitory, computer-readable medium, comprising computer-readable instructions that, when executed by one or more processors of one or more computers, cause the one or more computers to:
access a flow table, the flow table comprising one or more entries updated based on acknowledgment messages received relative to an active communication session with an endpoint system;
receive an early acknowledgment message;
receive, after the early acknowledgment message, a negative acknowledgment message corresponding to the active communication session; and
mitigate a data stall based on the negative acknowledgment message based on the one or more entries and receiving the negative acknowledgment message after the early acknowledgment message.

11. The non-transitory, computer-readable medium of claim 10, comprising computer-readable instructions that, when executed by the one or more processors of the one or more computers, cause the one or more computers to:
adjust, based on the data stall, a counter that tracks a number of occurrences of data stalls; and
retain, based on the counter, a copy of a packet after determining that the early acknowledgment message was received.

12. The non-transitory, computer-readable medium of claim 10, comprising computer-readable instructions that, when executed by the one or more processors of the one or more computers, cause the one or more computers to:
initiate the active communication session;
update the flow table to indicate the active communication session; and
retain, based on the flow table indicating the active communication session, a copy of an additional packet.

13. The non-transitory, computer-readable medium of claim 10, comprising computer-readable instructions that, when executed by the one or more processors of the one or more computers, cause the one or more computers to:
determine, based on the one or more entries, one or more extracted properties indicative of a plurality of acknowledgment messages previously transmitted via the active communication session;
receive, via the active communication session, an acknowledgment message;
extract one or more properties from the acknowledgment message; and
determine, based on the one or more properties matching the one or more extracted properties, that the acknowledgment message is the early acknowledgment message.

14. The non-transitory, computer-readable medium of claim 13, wherein the one or more properties comprise a Time-to-Live (TTL) parameter and one or more option parameters.

15. A method, comprising:
transmitting a packet via a communication session, a copy of the packet being retained in memory;
receiving, from a router, an early acknowledgment message corresponding to the packet;
deleting, from the memory, the copy of the packet based on the early acknowledgment message;
receiving a negative acknowledgment message associated with the communication session; and
mitigating a data stall based on the negative acknowledgment message.

16. The method of claim 15, comprising:
adjusting a count of a counter based on mitigating the data stall; and
implementing an override operation based on the count crossing a threshold.

17. The method of claim 16, wherein the override operation comprises retaining, based on the count of the counter crossing the threshold, a copy of an additional packet.

18. The method of claim 15, comprising
accessing memory comprising one or more extracted properties indicative of a plurality of acknowledgment messages previously transmitted via the communication session with an endpoint system; and
storing, based on identifying one or more properties of the early acknowledgment message as matching the one or more extracted properties, an indication that an acknowledgment message is the early acknowledgment message.

19. The method of claim 15, wherein mitigating the data stall comprises:
ending the communication session, the communication session in progress of transmitting respective packets of a packet flow;
establishing a new communication session; and
resuming, via the new communication session, transmitting the packet flow.

20. The method of claim 15, wherein mitigating the data stall comprises powering down circuitry associated with the communication session.
